(19) United States
(12) Patent Application Publication
(10) Pub. No.: US 2006/0031596 A1
(43) Pub. Date: Feb. 9, 2006

(54) Method and apparatus for providing an alternate route to system memory

(75) Inventors: Anton Blanchard, Marrickville (AU); Milton Devon Miller II, Austin, TX (US); Todd Alan Venton, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/912,501

(22) Filed: Aug. 5, 2004

(51) Int. Cl. G06F 3/00

(52) U.S. Cl. 710/9

(57) ABSTRACT

A method, apparatus, and computer instructions for routing data in a data processing system. Registers in a processor in the data processing system are configured to route memory requests to a local input/output controller rather than a local memory controller in the data processing system. Responsive to receiving the memory request at the input/output controller, the memory request is sent to a remote input/output controller located in a remote data processing system. The remote input/output controller sends the memory request to a remote memory controller in the remote data processing system to access remote memory in the remote data processing system.

### BACKGROUND OF THE INVENTION

1. Technical Field

The present invention relates generally to an improved data processing system. In particular, the present invention relates to a method and apparatus for processing data. Still more particularly, the present invention relates to a method, apparatus, and computer instructions for routing data in a data processing system.

2. Description of Related Art

Data processing systems, such as desktop computers, laptops, and servers, contain memory in many forms. For example, processors and data processing systems may have one or more levels of cache memory used to store data and/or instructions that may be reused with some frequency. System memory also is present. This type of memory is used to store data and computer programs. Requests from processors in a data processing system to access memory are handled by a memory controller. A memory request is processed by the memory controller to provide access, such as a read operation or a write operation with respect to the portion of a memory identified in the request.

In some cases, when testing a data processing system, it is desirable to boot or start the data processing system without using the local system memory in the data processing system. This type of booting of a data processing system is desirable if local system memory is unavailable. In some cases, testing of a data processing system may be desired without having to use local system memory. In other cases, the memory may be defective or portions of the input/output (I/O) may be unavailable or defective.

In other cases, using local memory is undesirable for running processor diagnostics. The use of local memory is undesirable because information in the memory may be changed, requiring restarting of the operating system. Having to restart the operating system each time a diagnostic is performed is undesirable because of the time it takes to restart the system.

Therefore, it would be advantageous to have an improved method, apparatus, and computer instructions for accessing processor state information and handling memory requests in a data processing system.

### SUMMARY OF THE INVENTION

The present invention provides a method, apparatus, and computer instructions for routing data in a data processing system. Registers in the data processing system are configured to route memory requests to a local input/output controller rather than a local memory controller in the data processing system. Responsive to receiving the memory request at the input/output controller, the memory request is sent to a remote input/output controller located in a remote data processing system. The remote input/output controller sends the memory request to a remote memory controller in the remote data processing system to access remote memory in the remote data processing system.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a diagram of components used in providing an alternate route to system memory in accordance with a preferred embodiment of the present invention;

FIG. 4 is a flowchart of a process for routing data using an alternate path through I/O subsystems in accordance with a preferred embodiment of the present invention; and

FIG. 5 is a flowchart of a process for accessing processor state information in accordance with a preferred embodiment of the present invention.

### DETAILED DESCRIPTION OF THE PREFERRED EMBODIMENT

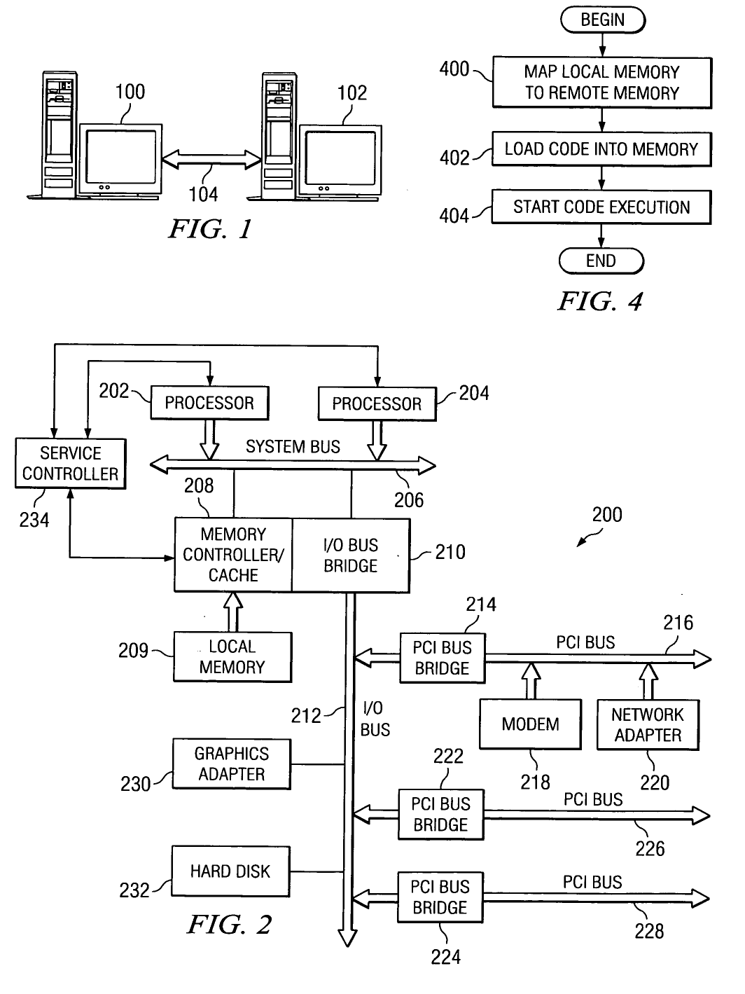

With reference now to the figures, FIG. 1 depicts a pictorial representation of a network of data processing systems in which the present invention may be implemented. In this example, the network contains data processing system 100 and data processing system 102. These data processing systems may take various forms. For example, these systems may take the form of a desktop computer, a work station, a server, or a laptop. Data processing system 100 and data processing system 102 are connected to each other through data link 104.

In these illustrative examples, this mechanism allows data processing system 100 to execute programs and run an operating system even if data processing system 100 does not have any memory present. Instead, the system memory in data processing system 102 is used. As a result, testing of a processor in data processing system 100 may be achieved if memory is absent or defective in data processing system 100.

Further, the processor or processors in data processing system 100 may be accessed and examined without changing the contents of system memory within data processing system 100. As a result, rebooting or restarting the operating system in data processing system 100 is unnecessary. With this mechanism, a program, such as a diagnostic program may be run from a remote memory.

Referring to FIG. 2, a block diagram of a data processing system that may be implemented as a server, such as server 100 in FIG. 1, is depicted in accordance with a preferred embodiment of the present invention. Data processing system 200 may be a symmetric multiprocessor (SMP) system including a plurality of processors 202 and 204 connected to system bus 206. Each processor in this example contains a single processor chip. Each chip may include one or more processor cores in the illustrative embodiments.

Alternatively, a single processor system may be employed. Also connected to system bus 206 is memory controller/cache 208, which provides an interface to local memory 209. I/O controller/bus bridge 210 is connected to system bus 206 and provides an interface to I/O bus 212. Memory controller/cache 208 and I/O controller/bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to remote data processing systems may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

With respect to data processing system 200, service controller 234 may be employed to monitor and send instructions to processor 202, processor 204, memory controller/cache 208, and I/O bus bridge 210.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

The present invention provides a method, apparatus, and computer instructions for routing data in a data processing system. The mechanism of the present invention configures registers in the data processing system to route memory requests to a local input/output controller in a local input/output subsystem, rather than to a local memory controller. Registers in various components may be modified to provide for rerouting memory requests to a memory in a remote data processing system. These components include, for example, a memory controller, I/O controller, and an I/O bridge.

As a result, a memory request received by the local input/output controller is routed to a remote input/output controller in a remote data processing system. The remote memory controller then accesses the remote memory in the remote data processing system. In this manner, local system memory in the data processing system is not needed.

This mechanism allows for the execution of programs in a data processing system without system memory being present in the data processing system. The mechanism of the present invention also allows for saving the state of the data processing system and executing a test case for diagnostic purposes without changing or altering the contents of the local data processing system's memory. The test case, which may be for a diagnostic purpose, is executed in a remote memory in a manner that execution of the operating system may resume with the state of the data processing system restored to the state before the interruption for diagnostic testing.

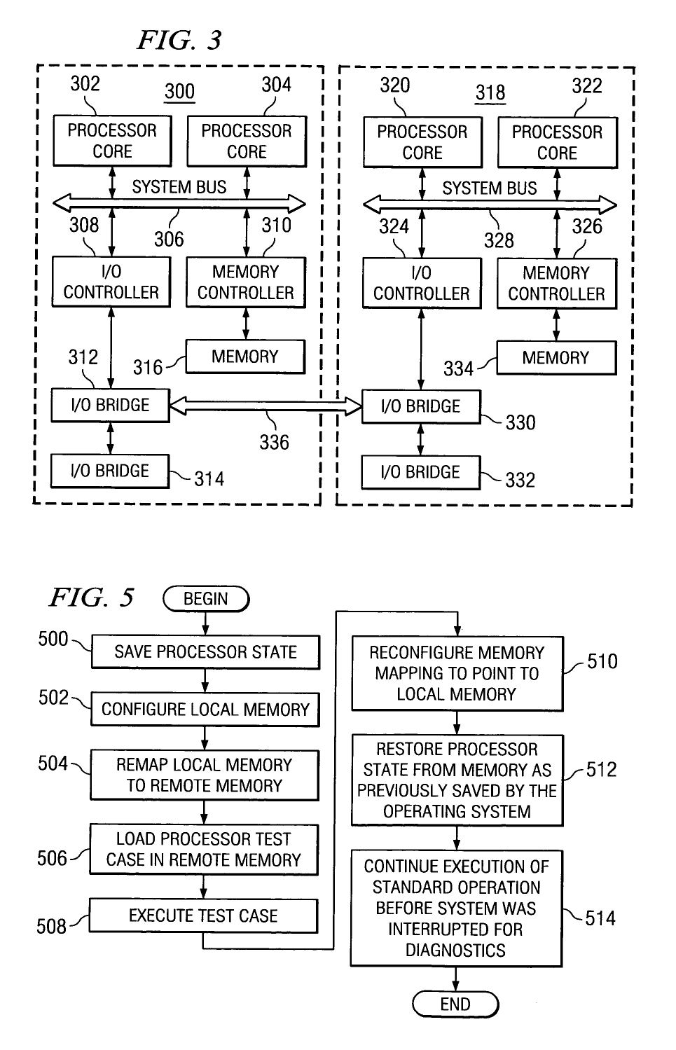

Turning now to FIG. 3, a diagram of components used in providing an alternate route to system memory is depicted in accordance with a preferred embodiment of the present invention. In this example, data processing system 300 contains processor core 302, and processor core 304. These two processor cores are connected to processor system bus 306. Depending upon the implementation, processor core 302 and processor core 304 may be located on the same chip or on different chips. Additionally, other numbers of processor cores may be used.

Input/output (I/O) controller 308 and memory controller 310 also are connected to system bus 306. I/O controller 308 is connected to I/O bridge 312, which in turn is connected to I/O bridge 314. I/O controller 308 and I/O bridge 312 may be implemented as I/O controller/bus bridge 210 in FIG. 2. I/O bridge 314 may be a PCI bus bridge, such as PCI bus bridge 214 in FIG. 2. These components are part of an input/output subsystem in data processing system 300.

Memory controller 310 provides a connection to memory 316, which is system memory in this example. Memory controller 310 may be implemented in memory controller/cache 208 in FIG. 2.

Data processing system 318 is an example of a data processing system through which memory requests may be routed to a system in an alternate route using I/O controls. Data processing system 318 contains processor core 320, processor core 322, I/O controller 324, and memory controller 326, which are all connected to system bus 328. I/O controller 324 is connected to I/O bridge 330, which in turn is connected to I/O bridge 332. Memory controller 326 is connected to memory 334. This memory is a system memory in these illustrative examples.

Data link 336 provides a connection between I/O bridge 312 in data processing system 300 and I/O bridge 330 in data processing system 318. In this example, registers in data processing system 300 are configured to route memory requests through I/O controller 308, rather than through memory controller 310. This configuring of the registers involves assigning address ranges normally assigned to memory controller 310 to I/O controller 308 and removing their assignment from memory controller 310. In these illustrative examples, the registers in memory controller 310, I/O controller 308, and I/O bridge 312 are changed to route the memory requests to I/O bridge 330.

When processor core 304 issues a memory request, the memory request is now routed to I/O controller 308. The memory request is then routed to I/O bridge 312. The request then proceeds to I/O bridge 330 in data processing system 318 through data link 336. This data link may take various forms. In these examples, the data link is a cable or wire that is designed to connect I/O bridge 312 to I/O bridge 330. The memory request then travels to system bus 328. At this time, memory controller 326 receives the memory requests and provides access to memory 334. This access, may be, for example a read or write access to system memory.

In this manner, an alternate route to a system memory is provided through the I/O subsystems in two data processing systems. As a result, data processing system 300 may execute a program even if memory 316 is unusable or absent because memory 334 is provided. Additionally, the execution of an operating system in data processing system 300 may be suspended to perform processor diagnostics on the processor state and preserve memory 316 to avoid having to restart the operating system after the diagnostics have been performed. This mechanism also may be used to perform diagnostics on the I/O subsystem. The diagnostics on processor core 302 or processor core 304 may be performed without disturbing the contents of memory 316. This goal is accomplished through the alternate routing of memory request to use memory 334. Thus, the execution of the operating system may be resumed after restoring the state of the processor core 304 and memory controller 310 and IO controller 308 without having to restart or reboot data processing system 300. Time is saved because reloading and reinitializing the operating system is not required.

In these illustrative examples, the memory requests are not cacheable memory requests. These types of memory requests may or may not be depending upon the design of the I/O subsystem.

Modifications to the operating system may be required in some cases to facilitate the routing of data to the I/O subsystems. Changes, if any, depend upon the particular operating system. For example, with the LINUX operating system on a platform with a PowerPC processor, modifications may be made to perform cache inhibited accesses. In addition the lwarx and stwcx instructions are removed from the code for operating system. These instructions are only functional on cacheable memory. The instructions are used to facilitate symmetric multiprocessing (SMP) programming. In this example, a single processor system is used and the instructions are not needed.

Turning next to FIG. 4, a flowchart of a process for routing data using an alternate path through I/O subsystems is depicted in accordance with a preferred embodiment of the present invention. This process is implemented to change the routing of memory requests such that memory requests are routed to an I/O controller, rather than a memory controller by a processor. This particular process is initiated to allow the data processing system to execute an operating system and programs without using system memory in the data processing system. Specifically, this process may be used to boot a data processing system without local memory. This feature is especially useful if the system memory in the data processing system is absent or damaged.

The process begins by mapping the local memory to a remote memory in another data processing system (step 400). This step may be performed by configuring a local I/O controller, such as I/O controller 308 in FIG. 3, to acknowledge a selected memory range. A verification is made that the selected memory range does not overlap address acknowledged by a memory controller, such as memory controller 310 in FIG. 3. If an overlap occurs, the required ranges are deconfigured in the memory controller. An I/O bridge, such as I/O bridge 312, is configured to route memory requests for the selected memory address range to an I/O bridge in a remote data processing system, such as I/O bridge 330 in FIG. 3. Additionally, an I/O controller on remote data processing system, such as I/O controller 324 may be configured to accept the selected address range and place the memory requests or data on the system bus in the remote data processing system. Additionally, a memory controller in the remote data processing system, such as memory controller 326 in FIG. 3, is configured to accept data in memory requests for the selected address range.

Code, such as an operating system or diagnostic tool, is loaded into the remote memory (step 402), and code execution is started (step 404). The process terminates thereafter.

Turning now to FIG. 5, a flowchart of a process for performing processing diagnostics is depicted in accordance with a preferred embodiment of the present invention. The process illustrated in FIG. 5 may be implemented to perform processor diagnostics while preserving the state of memory. In this example, the memory is preserved for resuming operation of the operating system without requiring a restart or reboot of the data processing system.

The process begins by saving the processor state (step 500). The functionality for this step may be present in the operating systems. Alternatively, the state may be saved by an external service controller, such as service controller 234 in FIG. 2. Step 500 typically involves steps, such as flushing all of the caches in the processor to memory, saving general purpose registers (GPRs), and special purpose registers (SPRs) in memory. Next, the local memory is configured not to respond to activity on the system bus (step 502). The local memory address range is remapped to a remote memory (step 504).

Then, a processor test case is loaded into the remote memory (step 506). In this example, the test case is for use of forming processor diagnostics. The test case is then executed (step 508). After execution of the test case, the memory mapping is reconfigured to point to the local memory (step 510). The processor state is restored to the processor as previously saved by the operating system or service controller (step 512). Step 512 may be implemented using functions currently available in operating systems. Thereafter, the execution of the standard operation in the data processing system continues from the point before the data processing system was interrupted for diagnostic testing (step 514) with the process terminating thereafter.

Thus, the present invention provides an improved method, apparatus, and computer instructions for routing memory requests in a data processing system. The mechanism of the present invention causes memory requests to be routed to an I/O subsystem, rather than to a memory subsystem. The memory requests are then routed to another data processing system. The memory requests are then processed by the memory controller in that data processing system.

This mechanism provides advantages, including one in which system memory is not required in the data processing system to execute an operating system or programs. System memory also is not required to perform diagnostics on components, such as a processor. This feature is provided through the routing of memory requests for processing by memory controller in another data processing system.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for routing data, the method comprising:
configuring registers in a processor in the data processing system to route memory requests to a local input/output controller rather than a local memory controller in the data processing system;
responsive to receiving the memory request at the local input/output controller, sending the memory request to a remote input/output controller located in a remote data processing system, wherein the remote input/output controller sends the memory request to a remote memory controller in the remote data processing system to access remote memory in the remote data processing system.

2. The method of claim 1, wherein the configuring step includes:
changing addresses in the registers to ones for the local input/output controller.

3. The method of claim 1 further comprising:
accessing the remote memory in the remote data processing system.

4. The method of claim 1 further comprising:
placing the data processing system in a suspended state prior to initiating the configuring step;
analyzing a state of the processor after initiating the configuring step.

5. The method of claim 4 further comprising:
removing the data processing system from the suspended state to continue operation without requiring restarting an operating system in the data processing system.

6. The method of claim 1, wherein the memory requests are cache inhibited requests.

7. The method of claim 1, wherein the configuring step is performed using a debug program.

8. The method of claim 1, wherein registers are configured through a Joint Test Action Group bus in the processor.

9. A data processing system comprising:
a local processor having registers used to direct memory requests to a set of addresses; and
a local input/output controller configured for communication with a remote input/output controller in a remote data processing system, wherein the registers are configured such that the set of addresses are first addresses for the local input/output controller in place of second addresses for a local memory controller, resulting in memory requests being directed towards the local input/output controller, which routes the memory requests to the remote input/output controller.

10. The method of claim 9, wherein the communication with the remote input/output controller is facilitated using cable connecting the local input/output controller to the remote input/output controller.

11. A data processing system for routing data, the data processing system comprising:
configuring means for configuring registers in a processor in the data processing system to route memory requests to a local input/output controller rather than a local memory controller in the data processing system;
sending means, responsive to receiving the memory request at the local input/output controller, for sending the memory request to a remote input/output controller located in a remote data processing system, wherein the remote input/output controller sends the memory request to a remote memory controller in the remote data processing system to access remote memory in the remote data processing system.

12. The data processing system of claim 11, wherein the configuring means includes:
changing means for changing addresses in the registers to ones for the local input/output controller.

13. The data processing system of claim 11 further comprising:
accessing means for accessing the remote memory in the remote data processing system.

14. The data processing system of claim 11 further comprising:
placing means for placing the data processing system in a suspended state prior to initiating the configuring means;
analyzing means for analyzing a state of the processor after initiating the configuring means.

15. The data processing system of claim 14 further comprising:
removing means for removing the data processing system from the suspended state to continue operation without requiring restarting an operating system in the data processing system.

16. The data processing system of claim 11, wherein the memory requests are cache inhibited requests.

17. The data processing system of claim 11, wherein the configuring means is implemented using a debug program.

18. The data processing system of claim 11, wherein registers are configured through a Joint Test Action Group bus in the processor.

19. A computer program product in a computable readable medium for routing data, the computer product comprising:
first instructions for configuring registers in a processor in the data processing system to route memory requests to a local input/output controller rather than a local memory controller in the data processing system;
second instructions, responsive to receiving the memory request at the local input/output controller, for sending the memory request to a remote input/output controller located in a remote data processing system, wherein the remote input/output controller sends the memory request to a remote memory controller in the remote data processing system to access remote memory in the remote data processing system.

20. The computer program product of claim 19, wherein the first instructions includes:
sub-instructions for changing addresses in the registers to ones for the local input/output controller.

21. The computer program product of claim 19 further comprising:
third instructions for accessing the remote memory in the remote data processing system.

22. The computer program product of claim 19 further comprising:
third instructions for placing the data processing system in a suspended state prior to initiating execution of the first instructions;
fourth instructions for analyzing a state of the processor after initiating execution of the first instructions.

23. The computer program product of claim 22 further comprising:
fifth instructions for removing the data processing system from the suspended state to continue operation without requiring restarting an operating system in the data processing system.

24. The computer program product of claim 19, wherein the memory requests are cache inhibited requests.
